(19) United States
(12) Patent Application Publication
(10) Pub. No.: US 2017/0270253 A1
(43) Pub. Date: Sep. 21, 2017

(54) SYSTEM, METHOD AND DEVICE FOR IDENTIFYING AN APPROPRIATE HEALTHCARE SERVICE PROVIDER AND PROVIDING A HEALTHCARE REFERRAL

(71) Applicant: SIEMENS HEALTHCARE GMBH, ERLANGEN (DE)

(72) Inventor: SULTAN HAIDER, ERLANGEN (DE)

(21) Appl. No.: 15/070,493

(22) Filed: Mar. 15, 2016

(51) Int. Cl. G06F 19/00; G06F 3/0484; G06F 17/30

(52) U.S. Cl. CPC G06F 19/325; G06F 19/328; G06F 19/327; G06F 19/3406; G06F 17/3087; G06F 3/0484

(57) ABSTRACT

A system for identifying an appropriate healthcare service provider for treating a particular medical concern of a patient, in addition to identifying a provider based on location and concern to be treated, identifies to the user the estimated availability of the treatment provider and an approximate cost, so as to permit the user to select the most appropriate provider for that patient. Identification of appropriate healthcare service providers, their estimated availabilities and approximate costs for services, is performed by a cloud server remote from the mobile device. A prediction engine or algorithm can be used by the cloud server to generate output results identifying appropriate healthcare service providers using data from the mobile device and a plurality of predictive models stored in a database accessed by the cloud server.

### BACKGROUND OF THE INVENTION

Field of the Invention

The present invention relates to a system, method and device for providing a healthcare referral and, more particularly, for providing an identification of an appropriate healthcare service provider based on information provided by a user via an application executed on a portable device.

Description of the Related Art

Traditionally, a patient in need of a specific treatment was referred to a specialist healthcare provider by a general practitioner. More recently, patients have used the Internet to look for doctors or specialists close to them or in neighboring localities. Further to the Internet, healthcare software applications, or “APPs”, downloadable to, and executable by, a mobile device are known. At least one such healthcare application is described in U.S. Patent Application Publication No. 2012/0101847 to Johnson et al. More particularly, Johnson et al., discloses a mobile medical information system in which web-based patient portals are accessed and medical history records of a patient are downloaded therefrom, based upon a user profile including personal information that uniquely identifies the patient. According to paragraph [0155] of Johnson et al., an IPHONE® or smartphone device is provided with application programming according to the invention of Johnson et al. Additionally, according to paragraphs [0160]-[0162] of Johnson et al., a disease, symptom or ailment selector is provided that can be used to find doctors and pharmacies within a particular zip code based on the selection of a particular disease (i.e., “sinusitis”) or symptom. See also, for example, paragraph [0183] and FIGS. 2, 5A and 19 of Johnson et al. However, the Johnson et al., system does not provide further deciding factors to the user from which the patient can choose the most appropriate healthcare service provider to meet that particular patient's needs.

In particular, patients need to identify the right healthcare service provider in a field where healthcare service providers are becoming increasingly competitive with diverse offerings and specialties. Often patients must find the most appropriate service provider on very short notice, especially for acutely ill patients. In the event of an emergency or an outbreak of epidemic, delays in medical treatment can result in irreversible health damage (e.g., in the case of stroke, acute cardiac failure, etc.). The increasingly mobile population and urbanization bring forth the need for a system that can guide a patient to a quick and cost effective treatment process.

Additionally, in large population countries, as well as in large cities like Shanghai, Delhi, Istanbul, Los Angeles, New York, etc., it could take a lot of time for a patient to reach a hospital. Also, the payment system in various hospitals could be different due to different contracts with insurance companies, which can further delay a patient's admission process. Some hospitals ask for a cash deposit from a patient before starting treatment. In case of the breakout of an epidemic, such as E. coli, SARS, Dengue fever, etc., this is problematic. The trend for the consolidation of healthcare service providers into hospital chains is leading to the use of healthcare portals. However, these portals are limited to use with only particularly associated healthcare providers.

There is a need in the art for a system and method accessible using a mobile device to determine a healthcare service provider most appropriate to the needs of a particular patient. More particularly, there is a need for a system and method that identifies health care service providers appropriate for meeting the needs of a patient and provides the user with information in addition to location and symptoms (i.e., forms of payment, cost of treatment, etc.), so that the user can determine the most appropriate provider to meet the needs of the patient.

### BRIEF SUMMARY OF THE INVENTION

The present invention is particularly suited to overcome those problems which remain in the art in a manner not previously known or contemplated. It is accordingly an object of the invention to provide a system and method that identifies an appropriate healthcare service provider for treating a particular medical concern of a patient , which, in addition to identifying a provider based on location and medical concern, provides the user with information about the availability of the treatment provider and an approximate cost, so as to permit the user to select the most appropriate provider for that patient. In one particular embodiment of the invention, identification of appropriate healthcare service providers, their availabilities (estimated availability and/or actual availability) and approximate costs for services, is performed by a cloud server remote from the mobile device. In a further embodiment, a prediction engine or prediction algorithm is executed by the cloud server to generate output results identifying appropriate healthcare service providers using data from the mobile device and a plurality of predictive models stored in a database accessed by the cloud server.

Although the invention is illustrated and described herein as embodied in a system, method and device for identifying an appropriate healthcare service provider and providing a healthcare referral, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The foregoing background, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1A is a simplified block diagram of a system in accordance with one particular embodiment of the invention;

FIG. 1B is a simplified block diagram of mobile device in communication with a remote service provider in a system according to one particular embodiment of the invention;

FIGS. 2A-2D are exemplary illustrations of possible input user interface according to one particular embodiment of the invention;

FIGS. 3A and 3B are exemplary illustrations of possible results displays presented on a user interface according to one particular embodiment of the invention; and

FIGS. 4A-4E are exemplary illustrations of possible input user interface according to another particular embodiment of the invention.

### DETAILED DESCRIPTION OF THE INVENTION

Before explaining the disclosed embodiment of the present invention in detail, it is to be understood that the invention is not limited in its application only to the details of the particular arrangement shown since the invention is capable of other embodiments. Also, the terminology used herein is for the purpose of description and not of limitation. For terms of the present application, an app or “APP” is defined as a self-contained application, program or piece of software that is designed to fulfill a particular purpose. In the preferred embodiments, such an APP is a mobile software application downloadable by a user to a mobile device, for execution thereon by a processor of the mobile device. A mobile device, as described herein is a portable, mobile computing device or client device, such as a smart phone, PDA or tablet, that includes a non-transitory memory for storing an APP and a processor for executing the stored APP on the mobile device, as well as a display and user interface for facilitating user interaction with the APP.

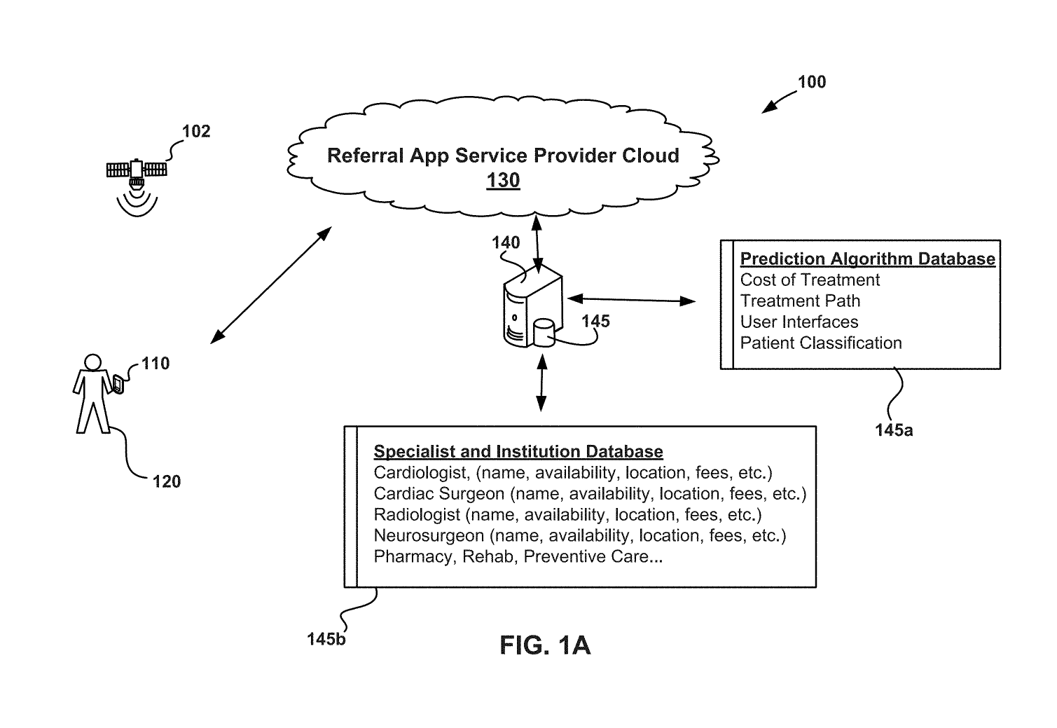

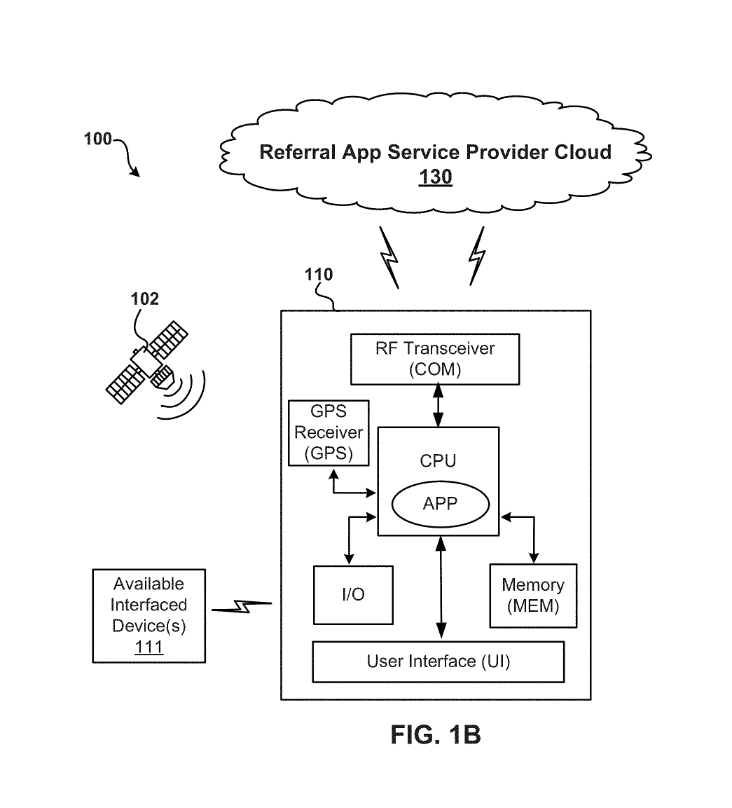

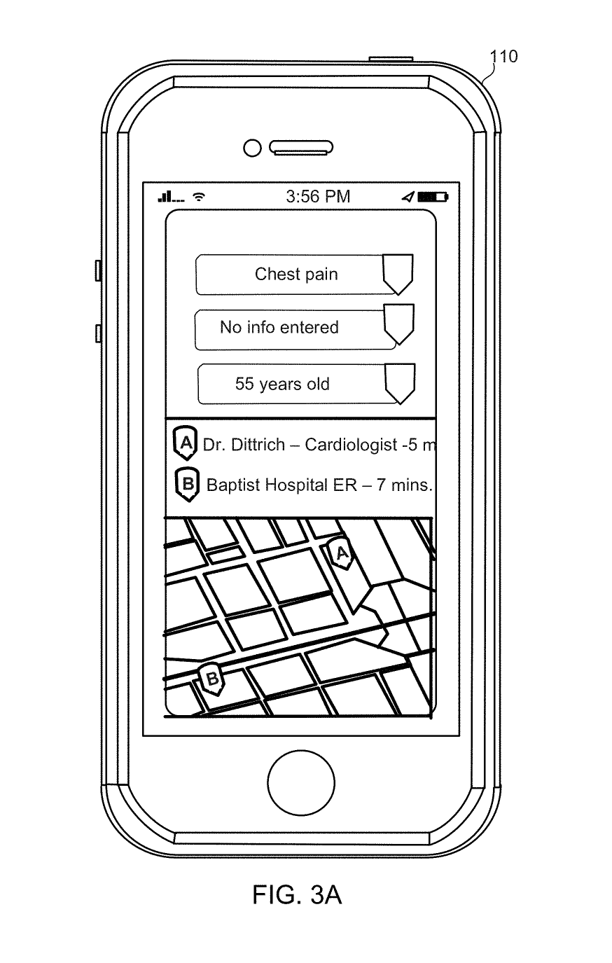

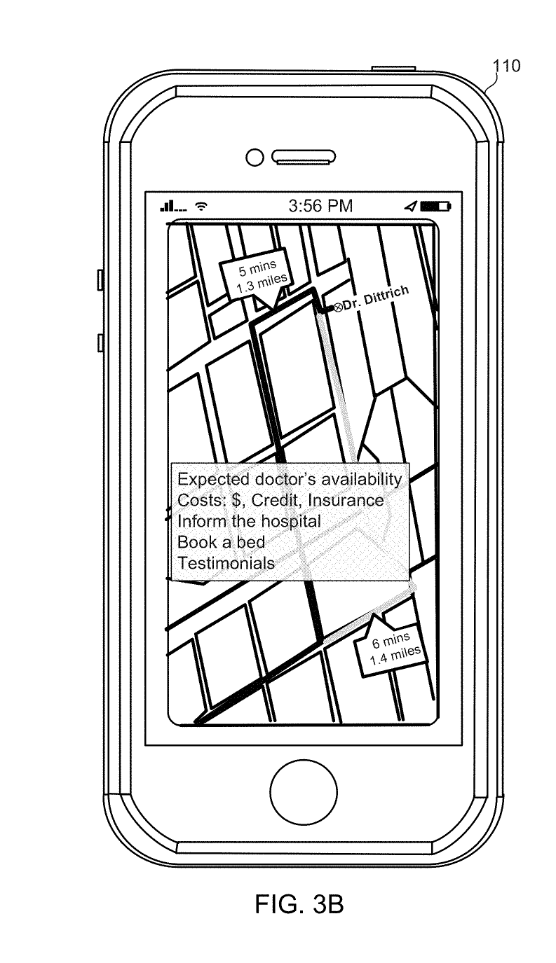

Referring now to FIGS. 1A-3B, there is illustrated one particular embodiment of a system 100, for providing a healthcare referral by identifying an appropriate healthcare service provider and treatment process based on user inputs, in accordance with one particular embodiment of the invention. In the system 100 of the present preferred embodiment, a user 120 (who may or may not be the patient) enters the available information into the interactive graphical user interface UI generated by the APP and analysis of the input data is performed remotely, using cloud computing.

More particularly, in one particular embodiment of the invention, a software application (“APP”) is made available, which is downloaded to the mobile device 110 by a user 120 and stored in non-transitory memory MEM. For example, the mobile device 110 can be a smartphone and the APP can be made available from the APPLE® or Android® store for downloading on a particular mobile device 110, or can be downloaded as a file provided directly by the APP creator or affiliate. The referral APP of the present invention is executable by a processor CPU of the mobile device 110 to identify an appropriate healthcare service provider (“HSP”) offering a treatment appropriate for the patient, based on, in one particular embodiment, patient symptoms 112, known vital parameters 114 and/or certain additional patient parameters 116. However, this is not meant to be limiting, as more, fewer and/or different criteria can be used to determine the most appropriate HSP and/or treatment for a patient without departing from the scope and spirit of the present invention.

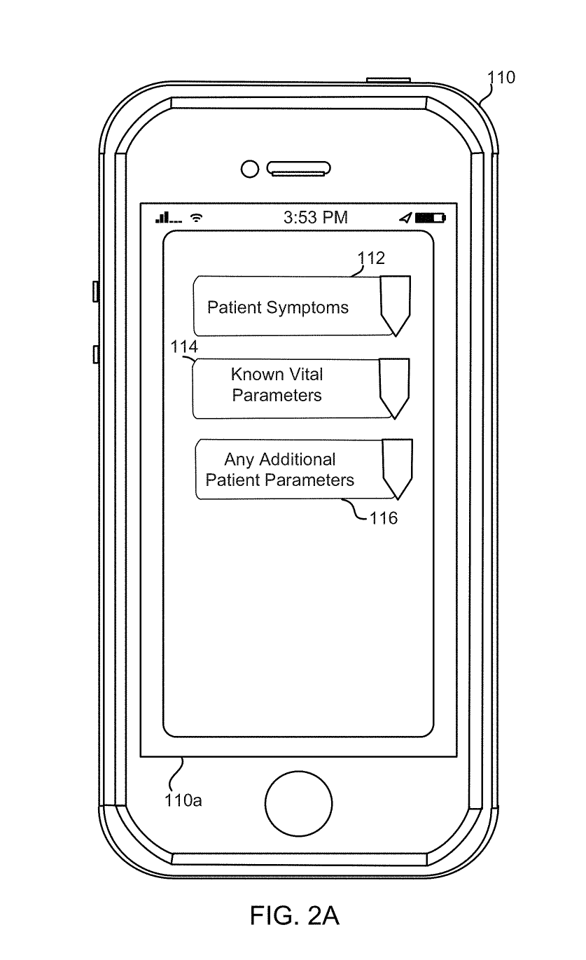

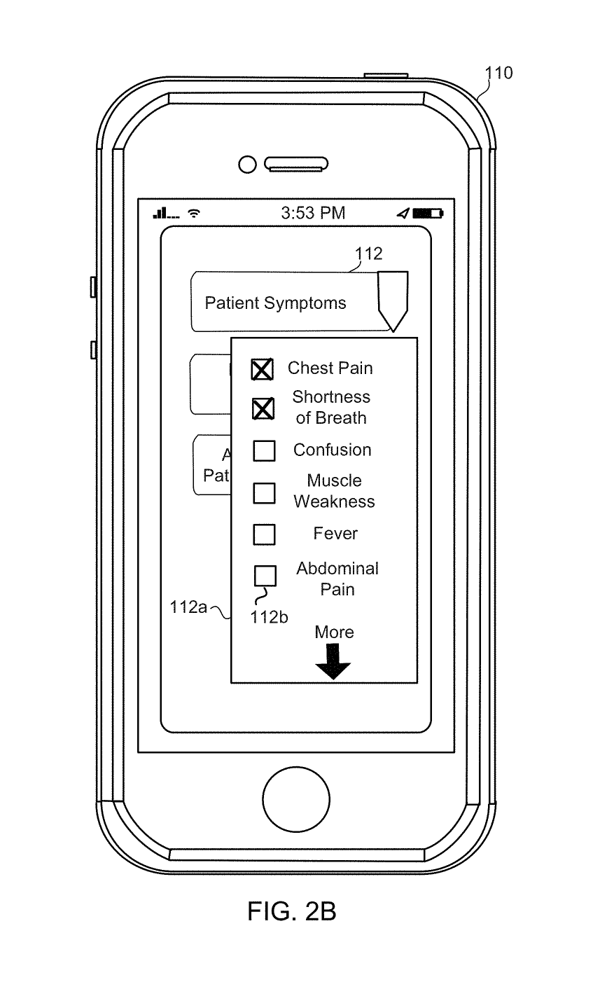

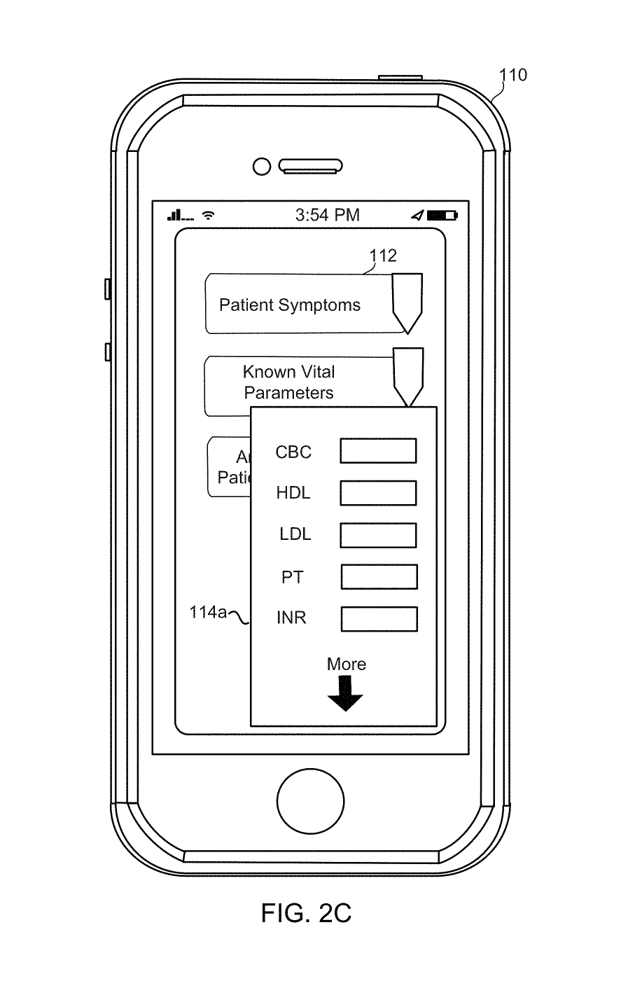

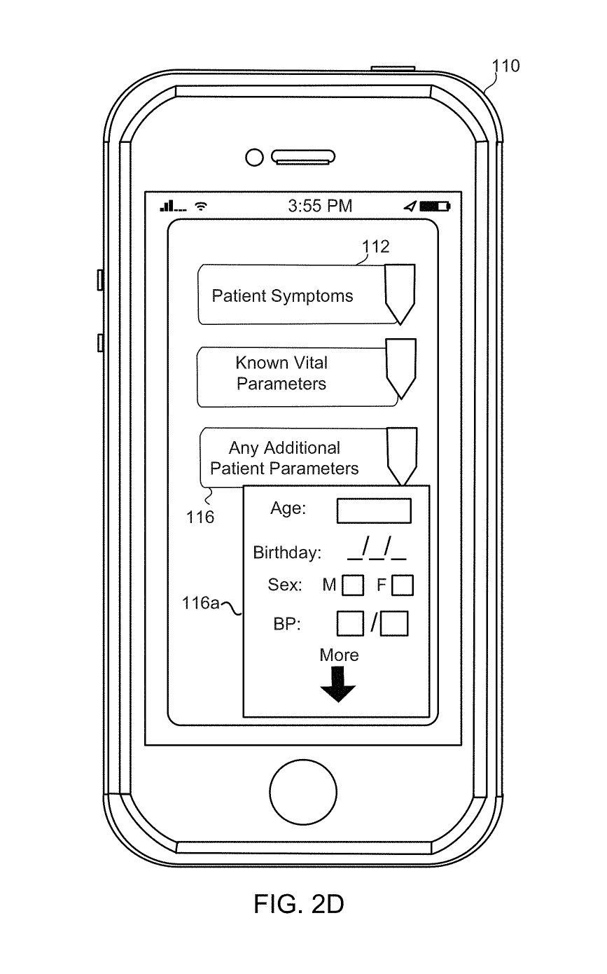

In the present particular embodiment, the user 120 interacts with the APP via a user interface UI of the mobile device 110. More particularly, in the present embodiment, the user 120 interacts with a touch-screen 110a of the mobile device 110, in order to make selections from drop-down menus generated and provided by the APP. For example, selecting the drop down menu Patient Symptoms 112, with a finger of the user 120 will provide a drop down menu 112a from which the user can select one or more the symptoms exhibited by the patient. For example, referring in particular to FIG. 2B, the user 120 can select symptoms experienced by the patient by checking off radio boxes 112b associated with each symptom.

Similarly, selecting the drop down menu Known Vital Parameters 114, with the finger of the user 120 will provide a drop down menu 114a from which the user can enter into blanks particularly known information about the patient's vital parameters, such as, but not limited to, the patient's complete blood count (CBC), high-density lipoprotein (HDL), low-density lipoprotein (LDL), prothrombin time (PT) and international normalized ratio (INR) values, etc. The APP can additionally receive data from one or more available device 111 interfaced with the mobile device 110 through a wired or wireless connection. For example, for purposes of performing an assessment, an available interfaced device 111 can be one that provides the App with one or more of: blood pressure, hemoglobin saturation, blood sugar level, pulse, temperature and/or other vital parameters. Medical devices that interface with mobile devices are known. See, for example, U. S. Patent Application Publication Nos. 2010/0279418, 2014/0231252, 2012/0156933 and 2014/0350367, among others, those applications being incorporated herein by reference in their entireties. Further, data can be provided by other devices that interface with the mobile device 110, such as a fitness tracker that monitors heart rate. One such device is the FITBIT® CHARGE HR made by Fitbit, Inc. Similarly, a device 111, or even a camera of the mobile device 110, can be used to capture a photograph of the emergency scene or a picture of an anatomical region of interest, which can be provided to the App and used in performing an assessment of the patient. Further, user interface UI can be linked to electronic records of a patient, either on the device or through a link to a remote database, which can be provided to the App and/or the cloud, for purposes of performing an assessment of the patient.

A further drop-down menu 116a can be provided, if desired, for entry of additional patient parameters such as, but not limited to, patient age, birthdate, gender, blood pressure (BP), etc. Also, some or all of the additional patient parameter information can be stored in the system 100 by the user during the initial setup of the APP.

In addition to the information entered by the user 120, the APP is configured to retrieve location information from the GPS receiver circuitry GPS of the mobile device 120, which determines location data based, at least in part, on signals from the GPS satellite network 102. This is not meant to be limiting, however. if desired, location information of the mobile device 110 can be obtained using a different system and/or method, such as cell tower triangulation, Globalstar network, or the like.

In the present embodiment, back end processing of the information provided by the user 120 to the APP, via the interactive user interface of the mobile device 110, is performed remotely by a cloud server 140 of a Referral APP Service Provider Cloud or “cloud” 130. Such a cloud server and APP could be implemented with, or like, for example, the Google® Cloud Platform and Prediction API available from Google, Inc., described, in part, in U.S. Pat. Nos. 8,229,864, 8,364,613, 8,706,659, 8,909,564 and 9,020,861 and U.S. Patent Application Publication Nos. 2015/0170048 and 2015/0186800 (collectively, the “Google Patents and Applications”), those patents and applications incorporated by reference herein in their entireties. The system can be trained for a vast number of possible medical concerns of a patient by preparation of predictive models addressing the possible medical concerns. This training can be performed by the Referral APP Service Provider or another entity.

In the present invention, communication circuitry of the mobile device 110 (i.e., rf transceiver COM) is used to transmit data to, and receive data from, the cloud 130, wherein it is processed by a cloud server 140. The cloud server 140 is configured to access cloud databases 145, and convert data provided by the mobile device 110 (including data entered into the user interface UI, as well as, data received from the I/O and/or GPS circuitry of the mobile device 110) to a referral for an appropriate HSP or HSPs for the particular patient. In particular, a prediction algorithm database 145a is provided having pre-trained predictive models addressing possible data entered by a user 120 into the user interface UI. Each input of the user 120 is processed by a respective predictive model and the outputs of the predictive models are used to provide appropriate HSP information from the cloud 130 to the mobile device 110 for display on the user interface UI of the mobile device 110.

More particularly, the outputs of the predictive models and training data in the prediction algorithm database 145a are used to obtain information as to particular HSPs registered in the specialist and institution database 145b. In one particular embodiment, the specialists and their institutions register with the referral APP service provider and, if desired, have a service level agreement or contract with the APP service provider. Information about the specialists and their institutions are then stored in the institution database 145b. In one particular example, the data record for the HSP stored in the database 145b includes information including, but not limited to, the areas of specialty of the HSP, the name of the HSP, typical or actual availability, location, fees, method of payment, insurances accepted, etc. The algorithm database 145a is used to correlate the information from the mobile device (e.g., user inputs/urgency/location and symptoms of the patient) to produce a result set from the HSP database based on, in one example, a predicted treatement, a cost of the predicted treatment, user interfaces for various users, patient classification (e.g., emergency patient, etc.), etc.

The database(s) 145 of the system 100 can be maintained centrally or can be decentralized, depending upon the service agreements between the service provider and the APP provider. More particularly, the system of the present invention uses a prediction engine or algorithm to process the patient information (i.e., symptoms, known vital parameters, additional patient parameters, location data) and determine an appropriate HSP for the patient. In one particular embodiment, the prediction algorithm is executed by the cloud server 140, and the prediction algorithm database 145a is part of the prediction algorithm engine. Alternately, if desired, the cloud server 140 can provide data from the databases 145 to a prediction algorithm (or prediction API, as described in, for example, the Google Patents and Applications incorporated herein) being executed as part of the APP. The prediction algorithm uses the data from the mobile device 110 to perform a patient risk assessment and, additionally, performs automated recognition for patterns indicative of certain diseases, such as cardiac arrest, strokes, etc.

The results can include, but are not limited to, a treatment plan, treatment costs, HSP availability and treatment period, optimized by the algorithm for each patient. Subsequently, the results produced by the prediction algorithm are formatted for output on the user interface UI of the mobile device 110. More particularly, based on these results, the user interface UI can present information to the user 120 about, for example, various available locations along with the medical facilities/specialties and time required to reach each location; the cost of the procedures, as well as the methods of payment accepted; treatment plans; and the opportunity to book an appointment from the APP using the user interface UI.

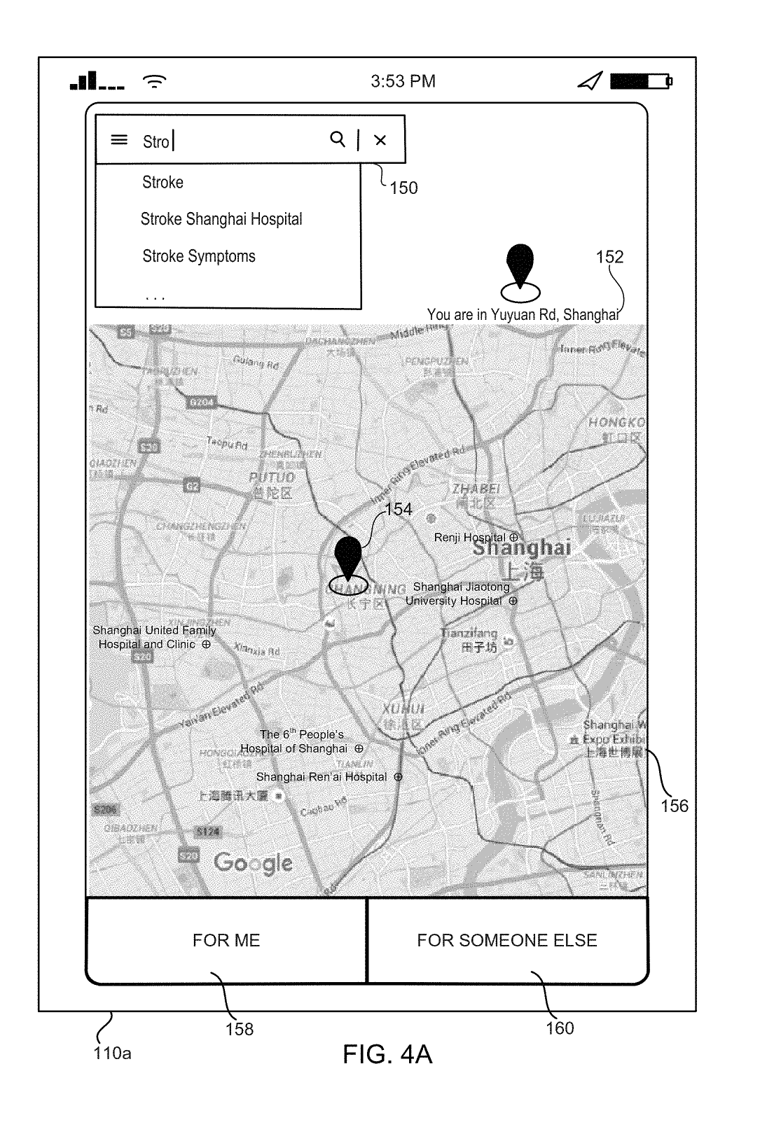

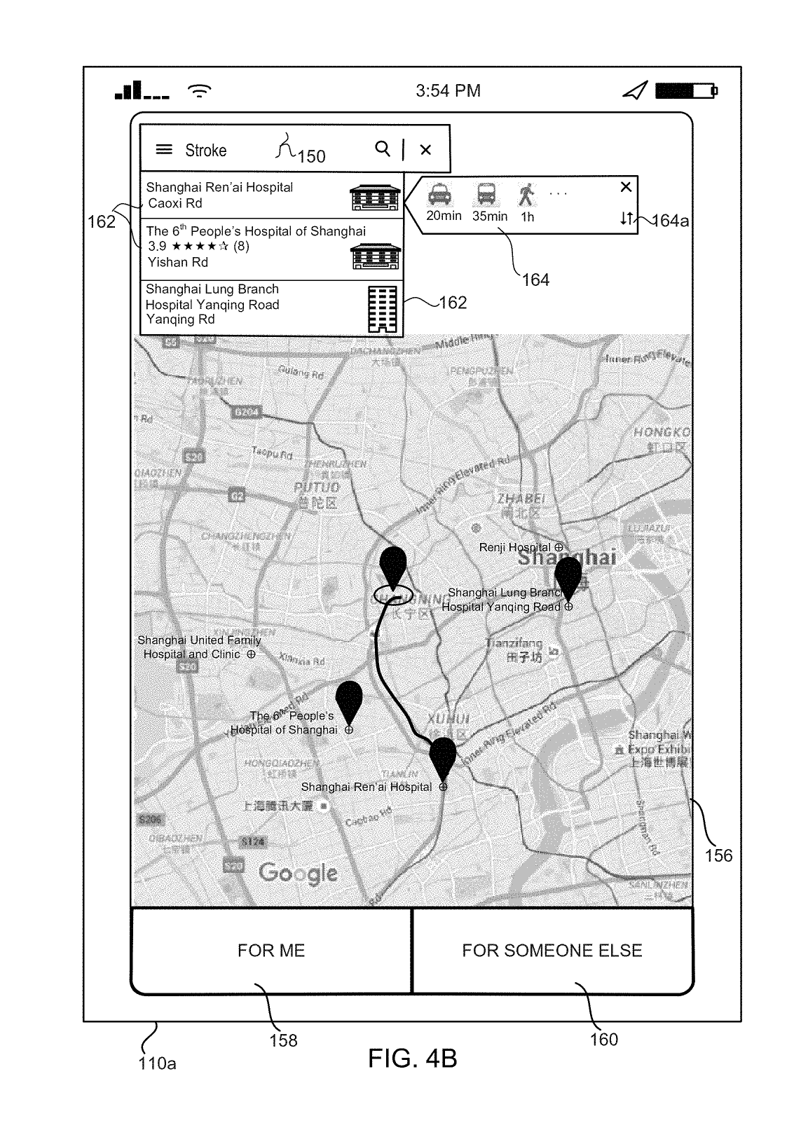

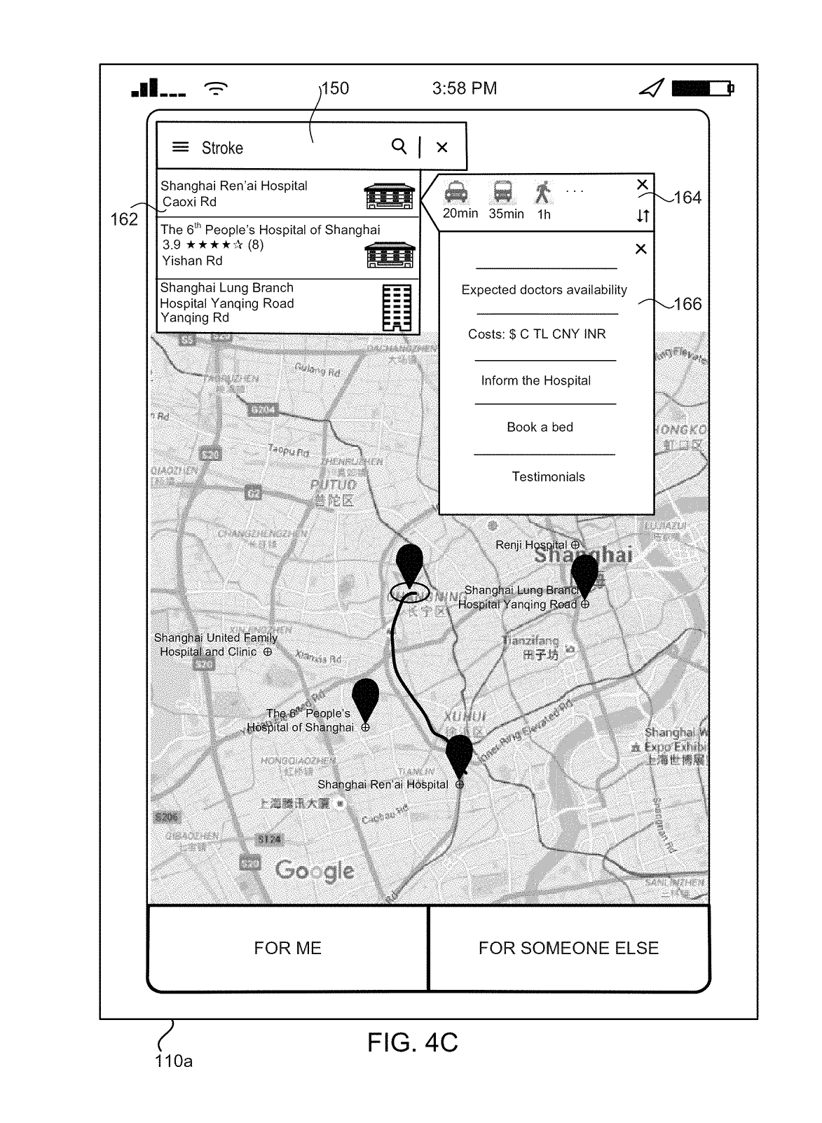

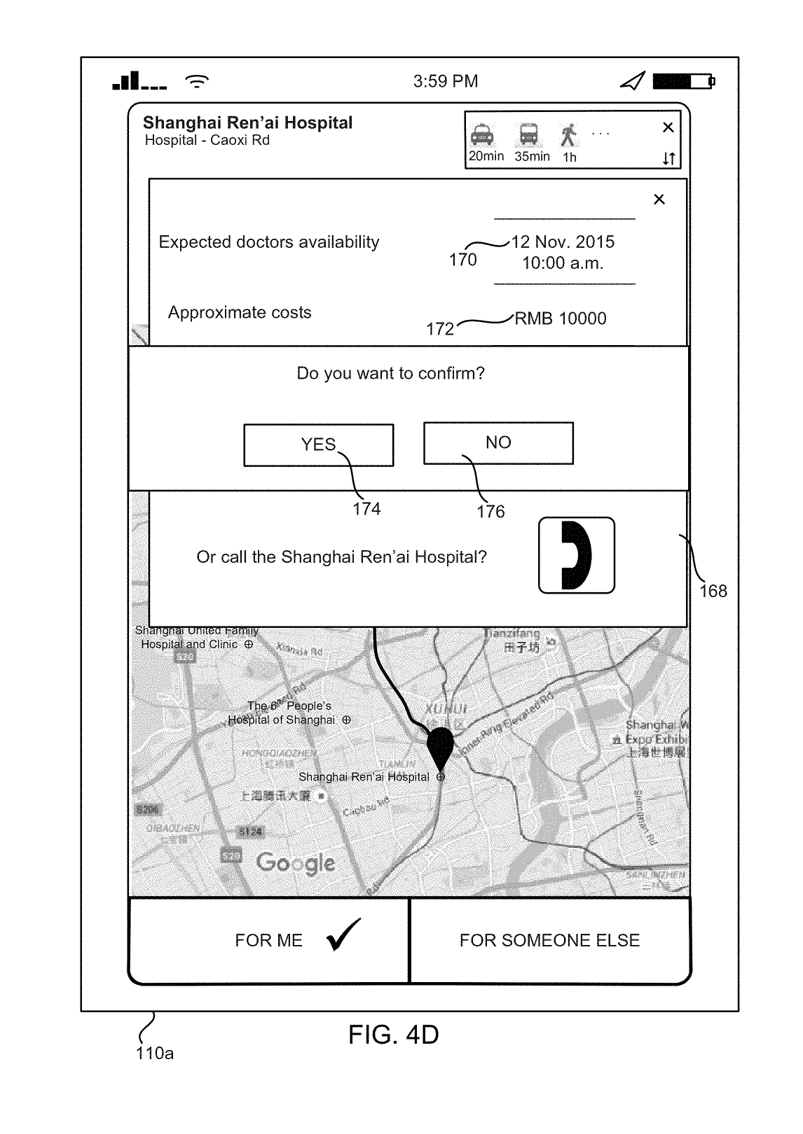

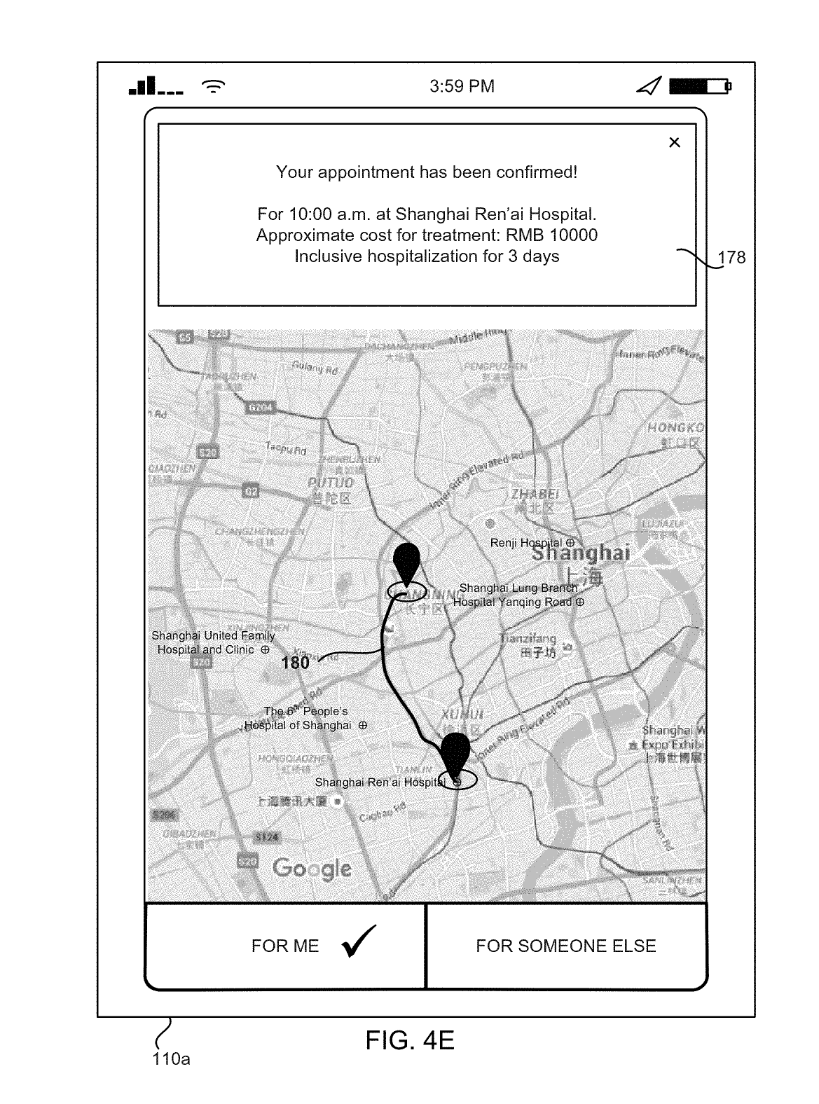

Referring now to FIGS. 1, 2 and 4A-4E, there is illustrated another user interface useful in a system including an APP according to one embodiment of the present invention. Instead of the drop-down menus of FIGS. 2A-2D, the illustrated interactive user interface UI displayed on the display 110a of the mobile device has an input text field 150 which uses a text prediction functionality (which is different from the prediction algorithm discussed herein). More particularly, as each character is typed into the text field 150, the APP suggests words the user 120 may wish to insert in the text field 150, based on, among other things, possible medical contexts and position information of the mobile device 110 (usually obtained from the GPS receiver GPS). For example, in FIG. 4A, a user has entered four keystrokes “Stro”. The APP can predict possible terms for selection by the user based on the context (medical symptoms/terms that start “stro”) and/or the location of the user. The user can select one of the suggested terms by tapping the term, at any time. Before final input of a search term in field 150, the APP uses the GPS module to determine a location of the user 120 and generate a map of environs surrounding the mobile device 110. Additionally, the location of the mobile device 110 is indicated on the user interface, both textually 152 and by a marker 154 superimposed on the map 156. HSPs matching the predicted result can be displayed on the map 156. As part of the information provided to the APP, the user 120 can select one of the soft buttons 158, 160 on the user interface UI to indicate whether treatment is being sought for the user 120 or for someone else. Further, as discussed above, data input to the I/O port of the mobile device 110 from an available interfaced device 111 can be provided to the cloud 130 for use by the prediction engine.

As illustrated in FIG. 4B, once the user 120 has entered a medical concern (i.e., symptom, illness and/or condition) in field 150, the system 100 can provide the user 120 with one or more HSP result 162, output by the predictive algorithm, based on the user entered information, as well as other information, such as geographic location information provided by the mobile device 110. The user can select an HSP result 162 by touch or by scrolling through the results using the user interface UI, in order to learn more information about a particular HSP. In the example illustrated, selection of an HSP result 162 provides a further display element 164 showing the user 120 an estimated travel time from the user's current location to the selected HSP result 162, via different methods of travel. An icon 164a in the display element 164 can indicate to a user 120 that more information is available. Selection of the display element 164 can be configured to bring up a further display element 166, illustrated more particularly in FIG. 4C.

The further display element 166 offers a plurality of selectable choices to the user 120. Among the choices offered to the user include a predicted cost of treatment for the concern entered into the field 150 and, in the illustrated example, the expected availability of an HSP professional to address the concern. This information is pulled from the institution database 145b and provided to the APP for display by the user interface UI. Additionally, the APP can be configured to inform the HSP of the upcoming arrival of a patient for treatment related to the medical concern or to book a bed in a facility for treatment of the medical concern. Additionally, in the present particular embodiment, the HSP result 162 can include rating and/or comment information entered by users to the database 145b, which can be displayed with, and accessed through, the HSP result 162. In the embodiment illustrated, testimonials about the HSP that are left by patients or visitors with the HSP can be accessed by selecting a “Testimonials” link on the further display element 166.

As illustrated in FIGS. 4D and 4E, the user 120 can interact with the interactive user interface UI to make and/or confirm an appointment for the patient (who is the user 120, in the illustrated case), at a particular time of expected availability 170 for the doctor (according to the database 145b). Importantly, the user is informed upfront, right in the display element 168, what the approximate cost 172 for rendering services will be, and, if desired, in what format payment can be made. By providing the cost as part of the display element 168, the user 120 or patient can compare the approximate cost of treatment for otherwise equivalent HSP providers. This permits the patient to shop around for a treatment that is most cost effective to the patient. As discussed herein, the approximate cost of treatment is a data element provided by the HSP and stored in the database 145b. Thus, in the invention, in addition to location and medical concern, the patient can choose an appropriate HSP based on an availability of the treatment provider and approximate cost. In one particular embodiment, the availability of the HSP for treating the patient is an estimated availability. Alternately, the actual availability of the HSP can be maintained in the database.

In one particular embodiment of the invention, the user is additionally given the option to connect to the HSP directly, by telephone, from the mobile device 110. Soft buttons 174, 176 generated by the APP permit the user to accept or decline an offered expected appointment date and time and effectively provides an acknowledgement of the user to the approximate cost of treatment 172 by the service provider. Upon acceptance of an offered appointment date or hospital stay, the Referral APP Service Provider will schedule the appointment or stay with the HSP.

After scheduling an appointment and/or stay with the HSP, the APP can generate a confirmation message 178 for display on the device 110. Additionally, the APP can be used to calculate and display an optimum route 180 from the user's current location to the selected HSP, and to guide the user 120 to the destination using the onboard GPS capability of the mobile device 110.

The system 100 of the present invention can be used by other individuals than the patient. If desired, an APP according to one embodiment of the present invention can be used directly by referring physicians to schedule a patient for various in-vivo and/or in-vitro tests. For example, the information about the kind of examination can be used to refer a stroke patient directly for magnetic resonance imaging, T1, T2, TOF, diffusion, perfusion sequence testing. This would save time, not only for the medical treatment authorization (MTA), but also for the radiologist, as the purpose of the examination is clearly defined by the referring physician.

Further, if desired, the APP can include an input that can be used patients can rate the services of a particular healthcare provider, and feedback can be given to improve services. Additionally, the system could be used by HSPs to offer their services to patients (e.g., Cardiac and mammo-screening) via advertisements that are generated and output on the user interface UI by the App and/or the cloud server 140. Further, the HSPs could offer various incentives for using their services to potential patients through the APP.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A system for identifying healthcare service providers at a mobile device, comprising:
the mobile device; and
a cloud server disposed remotely from said mobile device;
the mobile device, including:
a processor;
a memory storing a mobile software application (APP) that, when executed by the processor, causes the mobile device to generate an interactive graphical user interface on a display of the mobile device, the graphical user interface including at least one input field; and
a communication device communicating with said cloud server, including, for transmitting an input to said at least one input field to said cloud server and for receiving a set of output results identifying at least one healthcare service provider from said cloud server;
said cloud server configured to process the input in order to produce the set of output results from a database of said cloud server including information identifying a plurality of healthcare service providers, a location of each healthcare service provider, and at least one of an availability of said each healthcare service provider and an approximate cost of treatment by said each healthcare provider; and
the mobile device processor configured by the APP to process the set of output results received and to provide information on the user interface of the mobile device identifying said at least one healthcare service provider, said information including an identification of the at least one healthcare service provider, a location of the at least one healthcare service provider and at least one of an availability of said at least one healthcare service provider and an approximate cost of treatment by said at least one healthcare service provider.

2. The system of claim 1, wherein the mobile device further includes location determining circuitry used to generate information of a location of said mobile device and said set of output results is generated by said cloud server based on at least said input and said location.

3. The system of claim 1, wherein the set of output results includes the approximate cost of treatment by said at least one healthcare service provider.

4. The system of claim 1, wherein the cloud server executes a prediction algorithm to determine said set of results.

5. The system of claim 4, wherein said cloud server includes a database of predictive models used to generate said set of results based from at least said input.

6. The system of claim 1 wherein the cloud server is associated with a referral service provider having service agreements with said plurality of healthcare service providers.

7. The system of claim 6, wherein said mobile device processor configured by the APP additionally generates a user interface from which can be selected an appointment with said at least one healthcare service provider at a time of the availability of said healthcare service provider.

8. The system of claim 7, wherein said referral service provider facilitates the booking of said appointment selected.

9. A method for identifying at least one healthcare provider at a mobile device in a system according to claim 1, comprising the steps of:
generating a user interface on a display of the mobile device, the user interface including at least one input field;
receiving at least one input into the at least one input field;
providing the input to the cloud server for processing;
receiving, with the mobile device, a set of output results generated by the cloud server based on the at least one input; and
generating an output screen user interface displaying information identifying the at least one healthcare service provider, the information including an identification of the at least one healthcare service provider, a location of the at least one healthcare service provider and at least one of an availability of the at least one healthcare service provider and an approximate cost of treatment by the at least one healthcare service provider.

10. A system for identifying healthcare service providers to a mobile device, comprising:
a cloud server including a prediction algorithm configured to process data received from the mobile device in order to produce a set of output results identifying at least one healthcare service provider from a database of said cloud server including information identifying a plurality of healthcare service providers, a location of each healthcare service provider, and at least one of an availability of said each healthcare service provider and an approximate cost of treatment by said each healthcare provider;
the prediction algorithm utilizing a plurality of predictive models stored in said cloud server to generate said set of output results; and
a communication device configured to transmit said set of output results from the cloud server to the mobile device.

11. The system of claim 10, wherein said plurality of predictive models are trained by a referral service provider.

12. The system of claim 11, wherein said referral service provider has service agreements with said plurality of healthcare service providers.

13. The system of claim 10, wherein said set of output results includes information including an identification of the at least one healthcare service provider, a location of the at least one healthcare service provider and at least one of an availability of said at least one healthcare service provider and an approximate cost of treatment by said at least one healthcare service provider.

14. The system of claim 13, wherein the set of output results are provided to a mobile software application executing on the mobile device and provided to a user via a user interface generated by said mobile software application.

15. The system of claim 14, wherein the user interface permits selection of an appointment with said at least one healthcare service provider at a time of the availability of said healthcare service provider.

16. A method for identifying at least one healthcare provider at a mobile device in a system according to claim 10, comprising the steps of:
receiving at a cloud server, information including an input regarding a query for healthcare services from the mobile device;
processing the information with the cloud server in accordance with at least one predictive model stored in a database of the cloud server to identify at least one healthcare service provider; and
providing the mobile device with a set of output results relating to the at least one healthcare service provider identified generated by the cloud server in the processing step.

17. The method of claim 16, wherein the set of output results includes an identification of the at least one healthcare service provider, a location of the at least one healthcare service provider and at least one of an availability of the at least one healthcare service provider and an approximate cost of treatment by the at least one healthcare service provider.
